(19) United States
(12) Patent Application Publication
(10) Pub. No.: US 2025/0358396 A1
(43) Pub. Date: Nov. 20, 2025

(54) ADJUSTABLE STEREOSCOPIC CAMERA ALIGNMENT SYSTEM

(71) Applicant: X-Biomedical, Inc., Bryn Mawr, PA (US)

(72) Inventors: Matthew R. Maltese, Wallingford, PA (US); Mario Mischewski, Marthod (FR); Keting Zhao, Newtown Square, PA (US)

(73) Assignee: X-Biomedical, Inc., Bryn Mawr, PA (US)

(21) Appl. No.: 19/207,946

(22) Filed: May 14, 2025

Related U.S. Application Data
(60) Provisional application No. 63/647,920, filed on May 15, 2024.

(51) Int. Cl. H04N 13/246; H04N 13/239; H04N 13/344; H04N 17/00; H04N 23/50

(52) U.S. Cl. CPC H04N 13/246; H04N 13/239; H04N 13/344; H04N 23/50; H04N 17/002

(57) ABSTRACT

An adjustable stereoscopic camera system includes a first camera (210) mounted to a first mounting plate (220); and a second camera (250) mounted to a second mounting plate (260). The first mounting plate (220) is movable along a y axis in an x, y, z coordinate system and rotatable in α and γ directions about the x and z axes where α, β, and γ indicate directions of rotation about the x, y, and z axes respectively.

### BACKGROUND

In stereoscopic viewing systems, such as virtual reality (VR) or augmented reality (AR) headsets, accurate alignment of dual camera inputs is essential for producing a coherent and immersive three-dimensional visual experience. Typically, a headset is in communication with a pair of spatially separated cameras—each capturing an image stream intended for the left or right eye, respectively.

A significant technical challenge arises when the physical or virtual alignment between the cameras and the user's eyes deviates from an ideal stereoscopic configuration. This misalignment can be due to:

Mechanical Variation—Imperfect placement or mounting tolerances of the cameras on a headset or external rig.

Temporal Drift—Changes over time due to vibration, wear, or temperature-induced distortion.

User-Specific Variation—Differences in interpupillary distance (IPD) between users, which may not match the fixed baseline of the camera pair.

Perspective Distortion—Inaccuracies in mimicking the true geometry of the user's head position relative to objects in the field of view.

Improper alignment causes a range of perceptual artifacts, including:
Double imaging (ghosting)
Incorrect depth cues (vergence-accommodation conflict)
Motion sickness or eye strain
Reduced immersion or spatial awareness

Correcting for these disparities requires either mechanical calibration or real-time computational adjustment—such as warping, reprojection, or transformation of image data—to simulate proper parallax and convergence between the virtual camera views and the user's actual eye positions.

In use, each camera features a CMOS sensor and a lens with a unique alignment relative to the camera's frame. Because the CMOS/Lens-to-frame alignment is unique for each camera, there is a small amount of misalignment of the images from the cameras. Correcting misalignment can be done with software, but it can also be accomplished through simply shifting one or more of the two cameras.

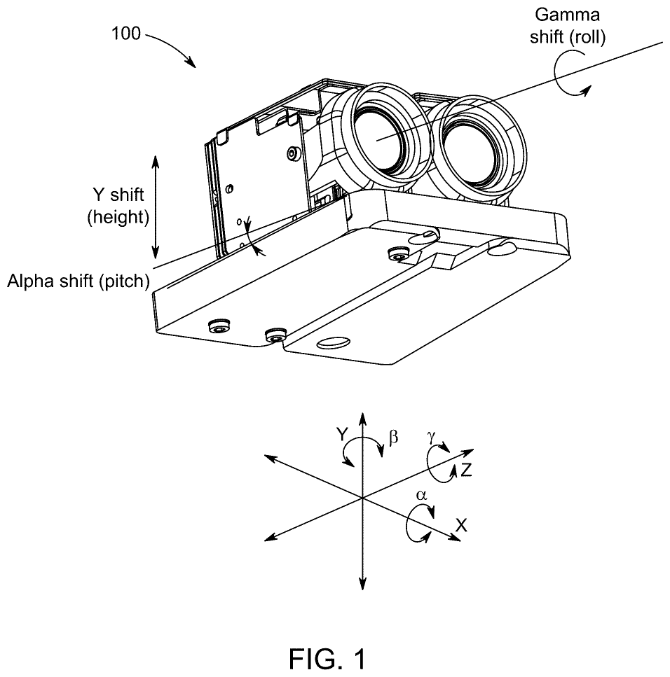

The term “shift” may refer to the movement of the camera in the x, y, z, α, β, and γ directions. FIG. 1 shows these directions and a camera 100 that can move linearly along any of the axes x, y, and z, or rotate about them in the α, β, and γ.

When using two cameras for stereoscopic image generation, the cameras may be angled at 4.6 degrees to one another to introduce converging optical axes, which more closely mimic natural human eye convergence for near-field depth perception.

This is because human eyes naturally rotate inward (converge) when focusing on near objects. Angling the cameras inward at 4.6 degrees helps simulate this effect in a stereoscopic system, especially for objects located at typical arm's length or closer.

This improves the accuracy of depth cues and provides a more natural and immersive 3D experience, reducing the discrepancy between visual perception and proprioception.

Such an alignment and converging the cameras optically at a preset angle (e.g., 4.6°) can minimize computational reprojection or correction, reducing processing overhead compared to using parallel cameras and digitally “toeing in” the views.

The specific angle of 4.6 degrees may be chosen based on the expected convergence distance (e.g., 1-2 meters). At this convergence point, the left and right images naturally overlap, allowing users to fuse the stereoscopic pair with less effort and reduced eye strain.

One downside is that convergence-fixed cameras (non-parallel) can cause vertical parallax or keystone distortion in the background or far field. 4.6° may be a modest angle chosen as a compromise between near-field realism and minimizing far-field distortion.

Angling the cameras at 4.6° improves natural stereopsis for near-field objects in a headset system, reduces processing complexity, and enhances visual comfort, assuming the target usage involves viewing objects at relatively close distances.

### Summary of the Embodiments

An adjustable stereoscopic camera system includes a first camera (210) mounted to a first mounting plate (220); and a second camera (250) mounted to a second mounting plate (260). The first mounting plate (220) is movable along a y axis in an x, y, z coordinate system and rotatable in α and γ directions about the x and z axes where α, β, and γ indicate directions of rotation about the x, y, and z axes respectively.

### BRIEF DESCRIPTION OF THE EMBODIMENTS

FIG. 1 shows a camera with movement along and about each axis.

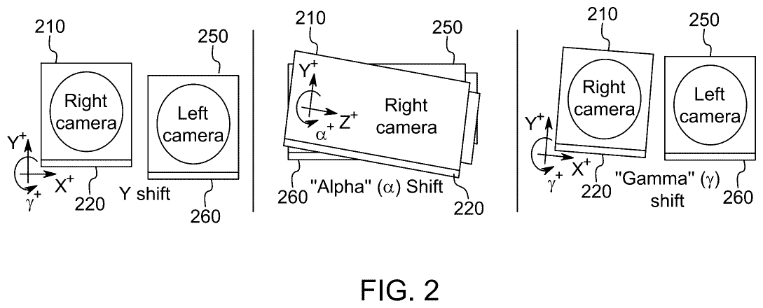

FIG. 2 shows a graphical depiction of how one of the two cameras described herein moves with respect to the other.

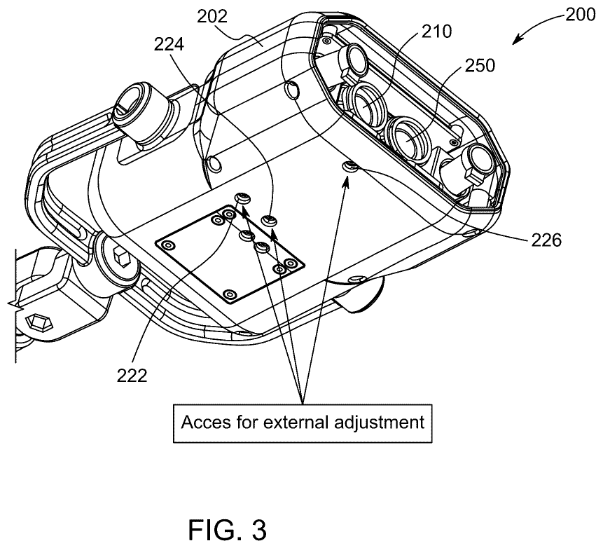

FIG. 3 shows a view of the stereoscopic camera system.

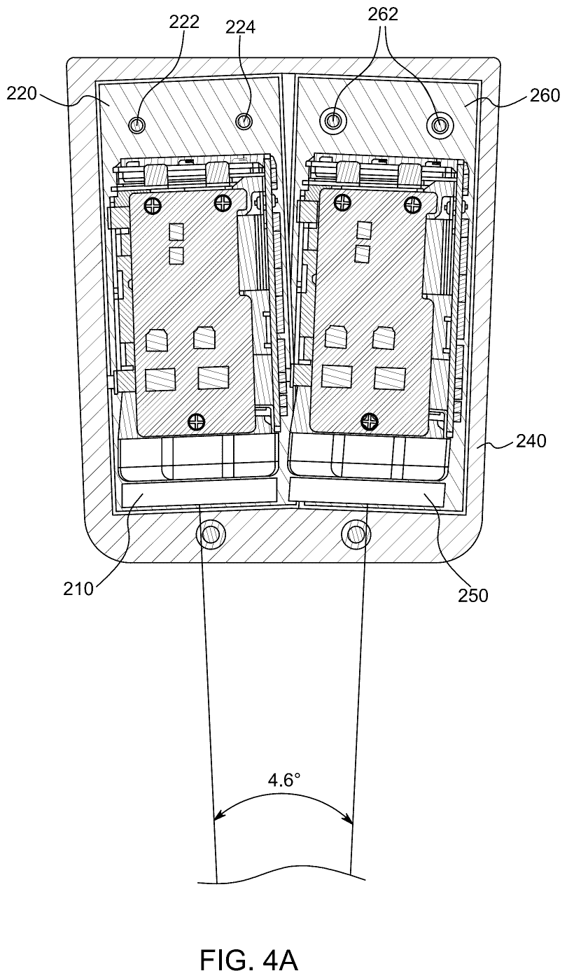

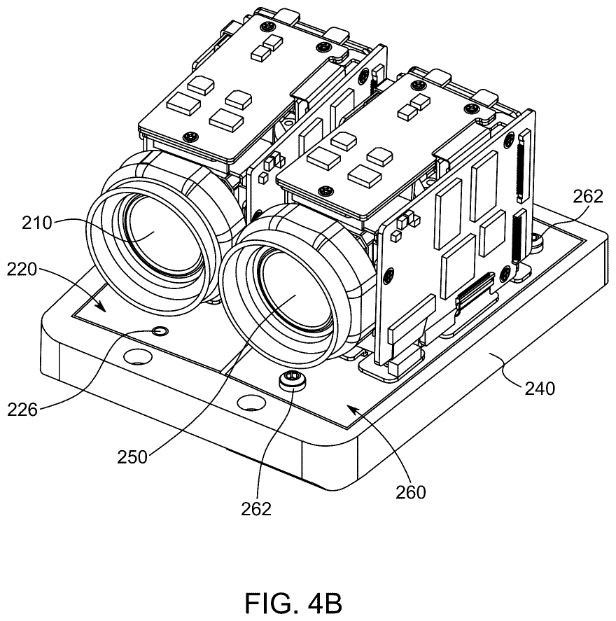

FIGS. 4A and 4B show the camera system with the housing removed.

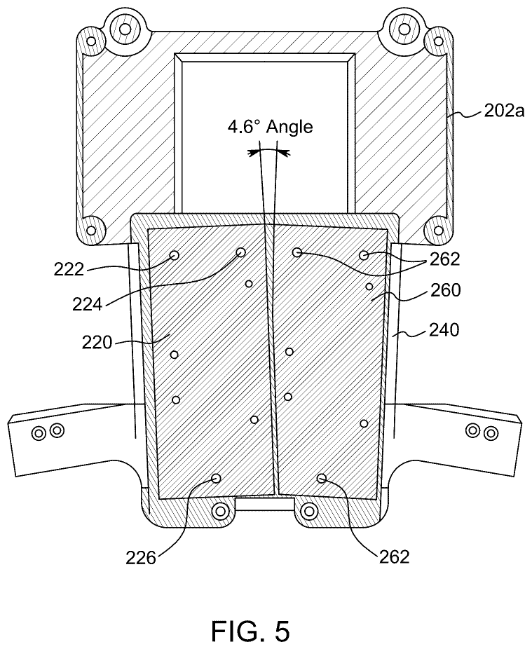

FIG. 5 shows the mounting plates and carriage.

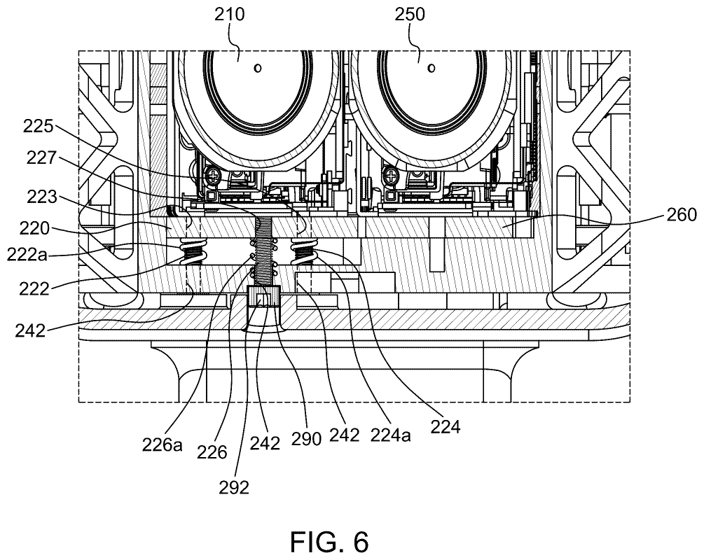

FIG. 6 is a partial cutaway through the housing showing the mounting plates and cameras.

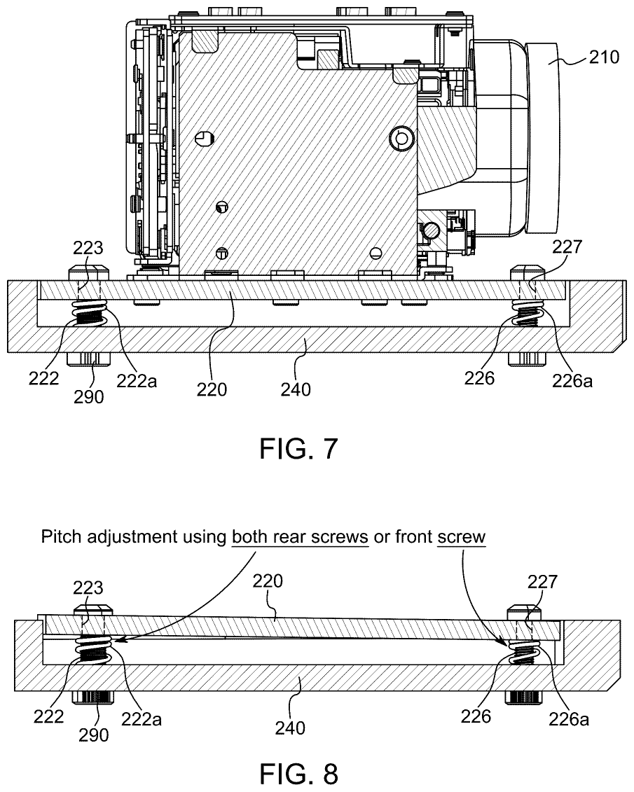

FIG. 7 shows a side view of view shown in FIGS. 4A and 4B.

FIGS. 8-12 show partial cutaway and isometic views of the mounting plates in various positions.

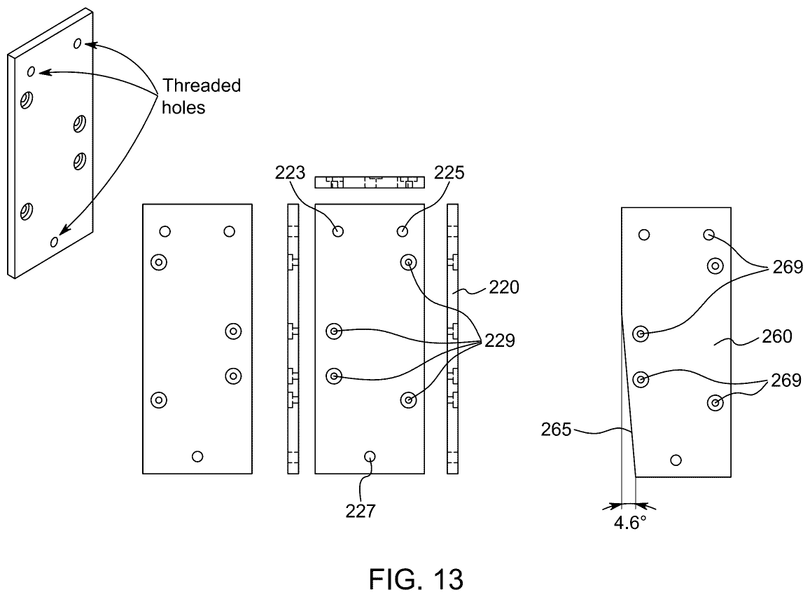

FIG. 13 shows different views of the mounting plates.

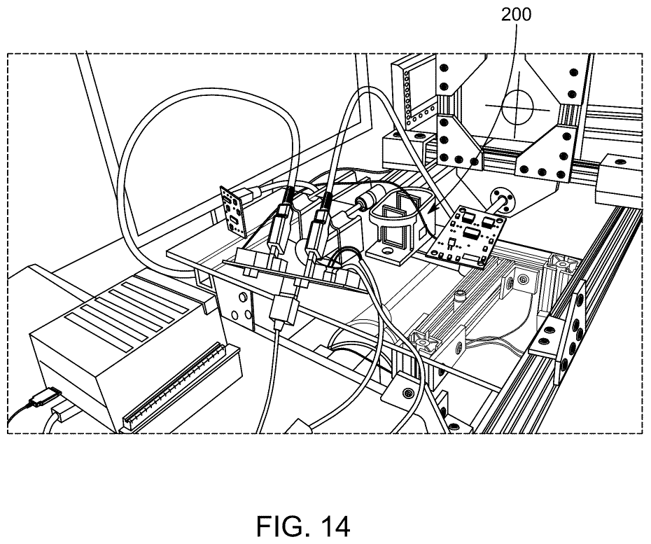

FIGS. 14-16 show the alignment procedure.

### DETAILED DESCRIPTION OF THE EMBODIMENTS

An adjustable stereoscopic camera alignment plate enables the adjustment of y, α, and γ, thereby aligning both cameras for optimal stereoscopic 3D at high magnification. Although more movement may be possible using more complicated movement systems, FIG. 2 contemplates just camera (and mounting plate) movement along/about y, α, and γ.

In this FIG. 2, a first left camera 210 mounted on a first mounting plate 220 moves and rotates with respect to a right second camera 250 mounted to a second mounting plate 260. Each of the successive three views shows movement in the y, α, and γ directions, respectively. The second camera 250 and second mount 260 could also be the moving camera, or both could move, though the inventors have found that just one camera moving and only moving in these directions addresses most of the stereoscopic alignment challenges noted above.

FIG. 3 shows the stereoscopic camera system 200 may be contained within a housing 202 that includes both cameras 210, 250. As shown in FIGS. 4A and 4B, the cameras 210, 250 may be mounted to the mounting plates 220, 260. The mounting plates 220, 260 may be attached to a single fixed carriage 240, which is itself attached to a bottom 200a of the housing. The housing 202 and carriage 240 may remain stationary with respect to the first camera 210 and first mounting plate 220, even as they move during calibration.

FIGS. 5-11, show how to align both cameras 210, 250, where only one camera position may be adjusted. For the system 200 described herein, the first left camera 250 and mounting plate 260 are in the fixed position. The second left camera plate 260 may be attached to the main carriage 240 using screws 262.

The movable second right eye plate 220 for the right camera 210 may be held in place by three fine thread machine screws 222, 224, 226 that each extend through holes 242 in the carriage plate 240 and a compression springs 222a, 224a, 226a. The compression springs 222a, 224a, 226a are compressed between the carriage plate 240 and the first movable plate 220. By tightening or untightening those 3 machine screws 222, 224, 226, a user can adjust the position of the first camera plate 220 and align both cameras. This application may refer to the first camera plate 220 as a spring-loaded plate.

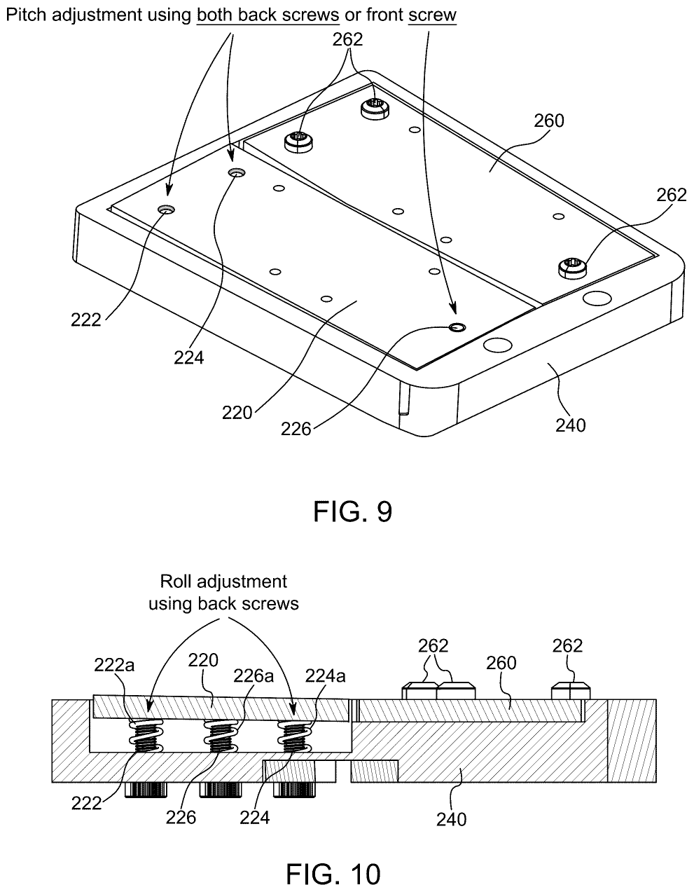

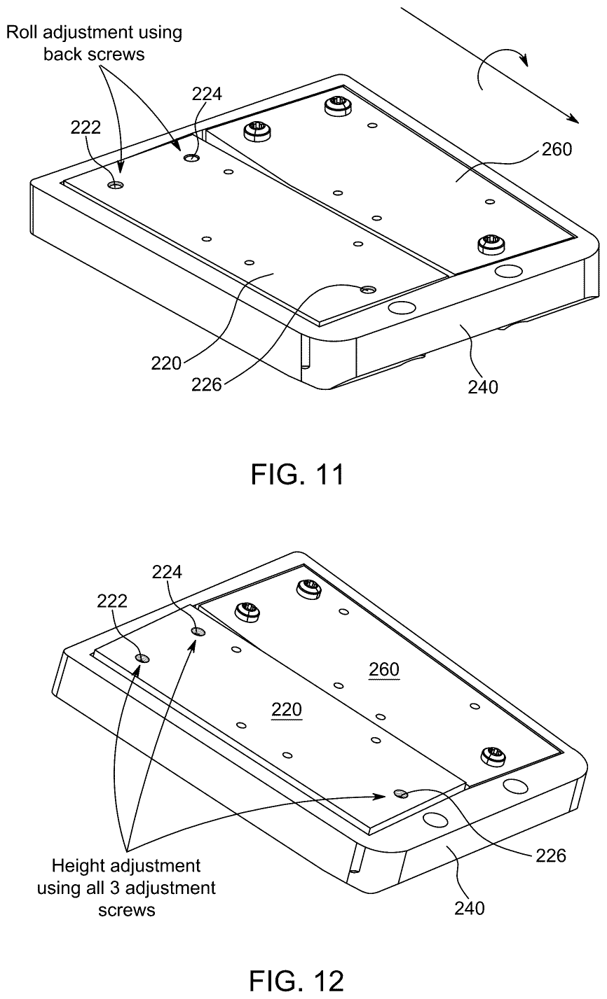

The horizontal position of the first plate 220 along the y axis may be adjusted by adjusting all three machine screws 222, 224, 226 (see FIG. 12). The horizontal alignment or pitch in the α rotation can be adjusted by adjusting either or both the 2 back screws, or the front screw (see FIGS. 8 and 9). A user may adjust both the back screws 222, 224 to adjust the γ rotation (see FIGS. 10 and 11).

The inventors tested the invention and studied the effects of the viewer's interpupillary distance (IPD) on the stereoscopic view range. As this system uses VR/AR glasses and not optical lenses, the position of the headset screens with respect to the eye has an effect on how a 3D image is seen. As the object moves closer or further from the camera system 200, the projection on the screens moves sideways. A perfect position is achieved when both images (left and right eye/screen) fuse to a stereoscopic 3D image, with both eyes looking to infinite distance (eyes parallel).

The system may be usable for different IPDs by adjusting the distance to the viewed object. We can also see that different persons have a different stereoscopic viewing range (the distance the camera system can move away from the target, closer or farther, while still keeping a stereoscopic image). This viewing range can be influenced by several variables, not only related to IPD, but also eye muscle control. Some people find it easier to “cross-eye” to view stereo-pair images, while others struggle with it.

As shown in FIG. 13, both plates 220 and 260 may be 3 mm-thick machined aluminum plates. The second fixed camera plate 260 is directly attached to the carriage plate 240 as described. The second fixed plate 260 may include an angled edge cut 265 at an angle of 4.6 degrees, as discussed above, to compensate for the angle of the cameras and allow both cameras to be positioned closer together. As contemplated, this angle is fixed (except for the slight shifts that may occur during alignment of the second plate 260. The second plate 260 includes camera mounting holes 269 through which camera mounting screws may extend to affix the second camera 250 to the second mounting plate 260.

The spring-loaded first plate 220 contains all the camera mounting holes 229 to attach the camera 210 thereto. Those mounting holes 229 should not obstruct the movement of the first plate 220, and therefore the screw heads for such screws may be recessed.

The first plate adjustment holes 223, 225, 227 may have a fine thread (M3×0.35) to allow for finer adjustments of the adjustment screws 222, 224, 226 that are necessary at higher magnification. An even finer thread may be used for finer adjustments, though the use of inserts might be necessary (instead of cutting the thread in the plate).

Each of those 3 adjustment screws 222, 224, 226 may be surrounded by a compression spring 222a, 224a, 226a, pushing the first plate 220 away from the carriage plate 240, with the adjustment screws acting against such springs.

The tension created by this spring assembly may help absorb vibrations due to transport, which could misalign the first plate 220. It is contemplated that the camera assembly may be portable and transportable, as described in U.S. Pat. No. 10,595,716, which is incorporated by reference as if fully set forth herein.

As shown, the first plate 220 is adjusted from below by turning the adjustment screws, perhaps engaging a larger screw head 290 in a recessed hexagonal key hole 292, to allow an adjustment from the exterior of the housing 202.

### Other Embodiments

The design may include two plates, one or both of which are suspended on a three-point mechanism. The three-point mechanism may allow for adjustment of the plate and, thus, the camera, creating y, alpha, and gamma displacement. In the current embodiment, the three-point mechanism is achieved by three screw-spring mechanisms upon which the moving first plate floats. The spring screws may be adjusted from the exterior of the scope head housing, to allow for easy adjustment without invasive opening of the protective scope head shell. The system uses an algorithm that uses a crosshair target to change the screw-spring settings to align the cameras.

In an alternative embodiment, the screw/spring mechanism may be replaced with electromechanical actuators such as a servo motor or linear actuator to achieve the same effect.

In another alternative embodiment, up to two additional floating plates may be added, oriented orthogonally to each other and to the first plate, to allow for adjustment in x, y, z, alpha, beta, and gamma directions.

The preferred materials are aluminum for the plates and either aluminum or polymer for the chassis.

In the future, the system may use one or both of the alternative embodiments described above, which will enable shifts via automatic means and/or shifts in all six directions (x, y, z, alpha, beta, gamma).

### Testing

### Test Environment

### Hardware Setup

The adjustable stereoscopic camera alignment system is set up on a rack system, which features a vertical frame with a crosshair target and is mounted on a horizontal pole, as shown in FIG. 14. The crosshair target frame can be manually moved along the pole to bring it closer or farther away from the adjustable stereoscopic camera alignment system. The camera is connected to the computer, which can be connected to an external display monitor for per-calibration or an AR headset, allowing the user to view the stereoscopic stream from the camera system.

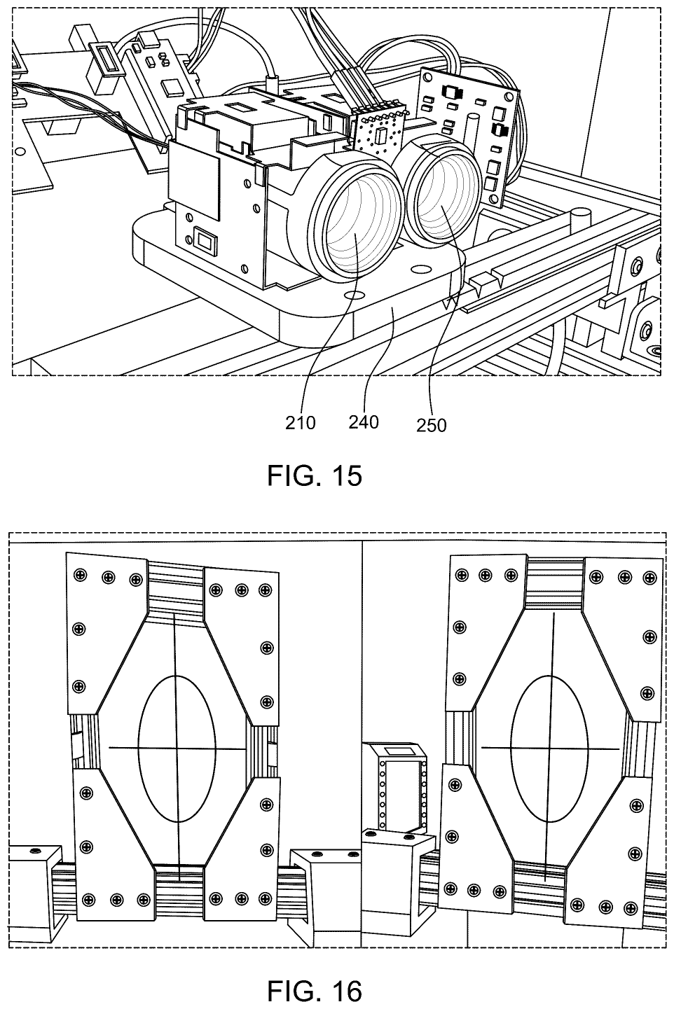

The time-of-flight sensor is used to gather distance information of the stereoscopic range for each user during testing. It is positioned on the same vertical plane such that its infrared ray intersects the central point of the two cameras' fields of view, as depicted in FIG. 15.

### Software Setup

The video stream from both cameras is read using Gstreamer Framework and a virtual crosshair is overlaid to both video streams to help initial calibration of the camera alignment system against the physical crosshair frame as described herein See FIG. 16.

### Test Methodology

First, calibrate an adjustable stereoscopic camera alignment system with zoom level set to maximum:

Move the physical crosshair frame until the vertical line of the crosshair is aligned with the virtual crosshair overlay from both streams.

Screw the adjustment screws from the floating plate camera, until the horizontal line of the crosshair is aligned with virtual crosshair overlay from both streams.

After the initial calibration, adjust the zoom to be 50% magnification and turn off the virtual crosshair overlay in the streaming pipeline. Place a 3D object at the center of the crosshair frame and connect the AR glasses with the camera system.

Next, the user needs to adjust the placement of AR glasses on their nose until both eyes can see the full screen range. The user can control the horizontal pole attached to the rack to move the vertical frame with the 3D object closer towards or farther away from the camera system, until the left and right camera streams stop fusing into a stereoscopic view, allowing for the lower and upper bounds of the stereoscopic range to be set.

### Test Result

The initial calibrated setup resulted in the cross point at 399 mm.

Table 1 shows partial data points of the stereoscopic range.

TABLE 1
stereoscopic range result

| Lower | Higher | Range |
|---|---|---|
| Bond (mm) | Bond (mm) | (mm) |
| 321 | 465 | 144 |
| 350 | 404 | 54 |
| 337 | 423 | 86 |
| 344 | 458 | 114 |
| 250 | 520 | 270 |
| 276 | 460 | 184 |
| 235 | 414 | 179 |
| 327 | 452 | 125 |

Table 1 shows that the current adjustable stereoscopic camera alignment system can cover a range of at least 5.4 cm spatial distance and as high as 27.0 cm spatial distance for the user.

Additionally, the user's interpupillary distance (IPD) is one of the factors that affect the stereoscopic view range for the user. The current system can be used comfortably for users whose IPD is within 55 mm to 70 mm range. If the user's IPD is narrower or wider than this range, the software IPD adjustment can be used from the AR glasses along with the current adjustment system.

In conclusion, the adjustable stereoscopic camera alignment system is a versatile and user-centric solution for precision AR applications. The test result shows the system's potential to deliver a personalized and immersive visual experience. Future enhancements may include automation in calibration and a wider range of IPD accommodations to further refine user comfort and the overall stereoscopic effect.

### Embodiments

Embodiment 1. An adjustable stereoscopic camera system comprising:
a first camera (210) mounted to a first mounting plate (220); and
a second camera (250) mounted to a second mounting plate (260);
wherein the first mounting plate (220) is movable along a y axis in an x, y, z coordinate system and rotatable in α and γ directions about the x and z axes where α, β, and γ indicate directions of rotation about the x, y, and z axes respectively.

Embodiment 2. The adjustable stereoscopic camera system of embodiment 1, wherein the first mounting plate (220) is coupled to a carriage plate (240) via a three-point spring/screw mechanism comprising three machine screws (222, 224, 226) that extend through corresponding compression springs (222a, 224a, 226a).

Embodiment 3. The adjustable stereoscopic camera system of embodiment 2, wherein the compression springs (222a, 224a, 226a) bias the first mounting plate (220) away from the carriage plate (240), and adjustment of the machine screws (222, 224, 226) alters the alignment of the first camera (210).

Embodiment 4. The adjustable stereoscopic camera system of embodiment 3, wherein:
(a) adjustment of all three screws (222, 224, 226) translates the plate (220) along the y axis,
(b) adjustment of screws (222 and 224) rotates the plate in the γ direction, and
(c) adjustment of only one of the screws (222 or 224) rotates the plate in the α direction.

Embodiment 5. The adjustable stereoscopic camera system of embodiment 4, wherein the adjustment screws (222, 224, 226) are accessible through the bottom of a housing (202) enclosing the cameras (210, 250).

Embodiment 6. The adjustable stereoscopic camera system of embodiment 5, wherein each adjustment screw includes a recessed hexagonal key hole (292) for tool access.

Embodiment 7. The adjustable stereoscopic camera system of embodiment 1, wherein the second mounting plate (260) is fixed to the carriage plate (240) and includes a 4.6-degree angled edge cut (265).

Embodiment 8. The adjustable stereoscopic camera system of embodiment 7, wherein the angled edge cut (265) allows the first and second cameras (210, 250) to be positioned closer together for improved stereoscopic effect.

Embodiment 9. The adjustable stereoscopic camera system of embodiment 1, wherein the mounting plates (220, 260) are machined from aluminum and are approximately 3 mm thick.

Embodiment 10. The adjustable stereoscopic camera system of embodiment 1, further comprising a housing (202) enclosing the cameras (210, 250) and mounting plates (220, 260), wherein the housing remains stationary relative to the first mounting plate (220) during movement thereof.

Embodiment 11. The adjustable stereoscopic camera system of embodiment 1, wherein the system is configured to display a virtual crosshair overlaid on the video stream from each camera to aid in alignment calibration.

Embodiment 12. The adjustable stereoscopic camera system of embodiment 11, further comprising a crosshair target frame configured to align with the virtual crosshair overlays during calibration.

Embodiment 13. The adjustable stereoscopic camera system of embodiment 1, further comprising a time-of-flight sensor aligned with the center point of the fields of view of the first and second cameras for determining a stereoscopic range.

Embodiment 14. The adjustable stereoscopic camera system of embodiment 1, wherein the cameras (210, 250) are positioned to simulate interpupillary distances (IPDs) ranging from 55 mm to 70 mm.

Embodiment 15. The adjustable stereoscopic camera system of embodiment 1, wherein the camera system is configured to cover a stereoscopic range of at least 5.4 cm to 27.0 cm spatial distance for a user.

Embodiment 16. The adjustable stereoscopic camera system of embodiment 1, wherein the adjustment mechanism enables camera alignment without opening the housing (202).

Embodiment 17. The adjustable stereoscopic camera system of embodiment 1, wherein the mounting plate (220) includes fine thread adjustment holes (223, 225, 227) for high precision alignment.

Embodiment 18. The adjustable stereoscopic camera system of embodiment 1, wherein the system is portable and the spring assembly absorbs vibration during transport.

Embodiment 19. The adjustable stereoscopic camera system of embodiment 1, wherein an electromechanical actuator is substituted for the spring/screw mechanism to automate alignment adjustments.

Embodiment 20. The adjustable stereoscopic camera system of embodiment 1, wherein additional floating plates are orthogonally arranged to enable adjustment in all six directions: x, y, z, α, β, and γ.

While the invention has been described with reference to the embodiments above, a person of ordinary skill in the art would understand that various changes or modifications may be made thereto without departing from the scope of the claims.

1. An adjustable stereoscopic camera system comprising:
a first camera (210) mounted to a first mounting plate (220); and
a second camera (250) mounted to a second mounting plate (260);
wherein the first mounting plate (220) is movable along a y axis in an x, y, z coordinate system and rotatable in α and γ directions about the x and z axes where α, β, and γ indicate directions of rotation about x, y, and z axes respectively.

2. The adjustable stereoscopic camera system of claim 1, wherein the first mounting plate (220) is coupled to a carriage plate (240) via a three-point spring/screw mechanism comprising three machine screws (222, 224, 226) that extend through corresponding compression springs (222a, 224a, 226a).

3. The adjustable stereoscopic camera system of claim 2, wherein the compression springs (222a, 224a, 226a) bias the first mounting plate (220) away from the carriage plate (240), and adjustment of the machine screws (222, 224, 226) alters alignment of the first camera (210).

4. The adjustable stereoscopic camera system of claim 3, wherein:
(a) adjustment of all three screws (222, 224, 226) translates the plate (220) along the y axis,
(b) adjustment of screws (222 and 224) rotates the plate in the γ direction, and
(c) adjustment of only one of the screws (222 or 224) rotates the plate in the α direction.

5. The adjustable stereoscopic camera system of claim 4, wherein the adjustment screws (222, 224, 226) are accessible through a housing (200) enclosing the cameras (210, 250).

6. The adjustable stereoscopic camera system of claim 5, wherein each adjustment screw includes a recessed hexagonal key hole (292) for tool access.

7. The adjustable stereoscopic camera system of claim 1, wherein the second mounting plate (260) is fixed to a carriage plate (240) and includes a 4.6-degree angled edge cut (265).

8. The adjustable stereoscopic camera system of claim 7, wherein the angled edge cut (265) allows the first and second cameras (210, 250) to be positioned closer together for improved stereoscopic effect.

9. The adjustable stereoscopic camera system of claim 1, wherein the mounting plates (220, 260) are machined from aluminum and are approximately 3 mm thick.

10. The adjustable stereoscopic camera system of claim 1, further comprising a housing (202) enclosing the cameras (210, 250) and mounting plates (220, 260), wherein the housing remains stationary relative to the first mounting plate (220) during movement thereof.

11. The adjustable stereoscopic camera system of claim 1, wherein the system is configured to display a virtual crosshair overlaid on a video stream from each camera to aid in alignment calibration.

12. The adjustable stereoscopic camera system of claim 11, further comprising a crosshair target frame configured to align with virtual crosshair overlays during calibration.

13. The adjustable stereoscopic camera system of claim 1, further comprising a time-of-flight sensor aligned with a center point of fields of view of the first and second cameras for determining a stereoscopic range.

14. The adjustable stereoscopic camera system of claim 1, wherein the cameras (210, 250) are positioned to simulate interpupillary distances (IPDs) ranging from 55 mm to 70 mm.

15. The adjustable stereoscopic camera system of claim 1, wherein the camera system is configured to cover a stereoscopic range of at least 5.4 cm to 27.0 cm spatial distance for a user.

16. The adjustable stereoscopic camera system of claim 1, wherein an adjustment mechanism enables camera alignment without opening A housing (200).

17. The adjustable stereoscopic camera system of claim 1, wherein the mounting plate (220) includes fine thread adjustment holes (223, 225, 227) for high precision alignment.

18. The adjustable stereoscopic camera system of claim 1, wherein the system is portable and a spring assembly absorbs vibration during transport.

19. The adjustable stereoscopic camera system of claim 1, wherein an electromechanical actuator is substituted for a the spring/screw mechanism to automate alignment adjustments.

20. The adjustable stereoscopic camera system of claim 1, wherein additional floating plates are orthogonally arranged to enable adjustment in all six directions: x, y, z, α, β, and γ.
